(19) United States
(12) Patent Application Publication
(10) Pub. No.: US 2018/0163446 A1
(43) Pub. Date: Jun. 14, 2018

(54) Gravity-Assisted Floor-Mounted Hinged Door Holder

(71) Applicant: George Royce Beall, Fredericksburg, TX (US)

(72) Inventor: George Royce Beall, Fredericksburg, TX (US)

(21) Appl. No.: 15/373,141

(22) Filed: Dec. 8, 2016

(51) Int. Cl. E05C 17/54

(52) U.S. Cl. CPC E05C 17/54

(57) ABSTRACT

A floor-mounted door holder for holding a door in an open position. The door holder has a base plate for attachment on a floor, and a top plate hinged to the base plate. The hinged attachment provides a pivot for the top plate, which is weight-biased to tilt toward the floor. The door holder is typically installed near a wall with the hinge facing outward, so that when the door is opened and moved toward the wall and over the door holder, the door flattens the top plate. After the door passes over the top plate, the top plate tilts back to its bias position and its upper edge engages the door.

### TECHNICAL FIELD OF THE INVENTION

This invention relates to hardware for holding doors open, and more particularly to floor-mounted door holders.

### BACKGROUND OF THE INVENTION

In the most general sense, a “door holder” can be any one of various objects or devices used to hold a door open or closed, or to prevent a door from opening too widely.

To hold a door open, the door holder may simply be a heavy solid object placed in the path of the door. These objects can range from spontaneously improvised objects, chosen simply because they are heavy, to artistic or whimsical designs.

Another type of door holder is the ubiquitous wedge-type door holder, which is a small wedge of wood, rubber, plastic, or other material. Manufactured wedges of these materials are commonly available. The wedge is kicked into position and the downward force of the door, now jammed onto the door holder, provides enough static friction to keep it motionless.

A third strategy is to equip the door with a holding mechanism. One such device is a short metal bar capped with rubber, or other high friction material, vertically hinged near the bottom edge of the door on the side that swings open and shut. When the door is to be kept open, the bar is swung down so that the rubber end touches the floor, and the bar braces the door open. When the door is to be closed, the stop is released by pushing the door slightly more open which allows the metal bar to be flipped upwards. Another example of a door holder has a magnet attached to the bottom of the door. When the door is open, the magnet on the door attaches to another magnet on the wall or to a small hub on the floor. The magnet is strong enough to hold the weight of the door, but weak enough to be easily pulled from the wall or hub.

Another type of door holder includes floor-mounted door holders. These door holders are typically mounted on the floor near a wall towards which the door is to be opened. They tend to have some sort of hinged plate, which is biased in an upward direction away from a floor mounted base plate. The spring compresses as the door is opened toward the wall, allowing the door to pass over the top plate. After the door passes over the top plate, the spring pushes the top plate back up against the bottom edge of the door, holding the door open.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a perspective view of the door holder, along the length of its non-hinged side and in its open position.

FIG. 2 is a side view of the door holder in its open position.

FIG. 3 is another perspective view of the door holder, viewed from the opposite end as FIG. 1.

FIG. 3A is a side view illustrating how the upper edge of the top plate engages a door.

FIG. 4 illustrates how the closing of a door over the door holder presses the top plate down against the base plate.

FIG. 5 is a perspective view of the door holder attached to a floor, in its open position, holding a door open against or close to a wall.

FIGS. 6 and 7 are perspective views of the installation and operation of the door holder.

FIGS. 8 and 9 are top views of the installation and operation of the door holder.

### DETAILED DESCRIPTION OF THE INVENTION

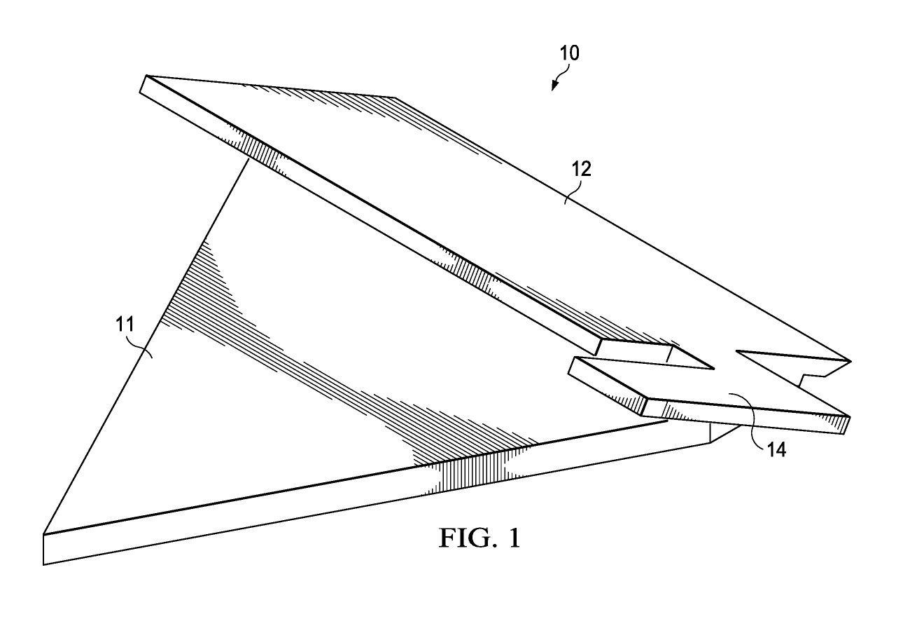

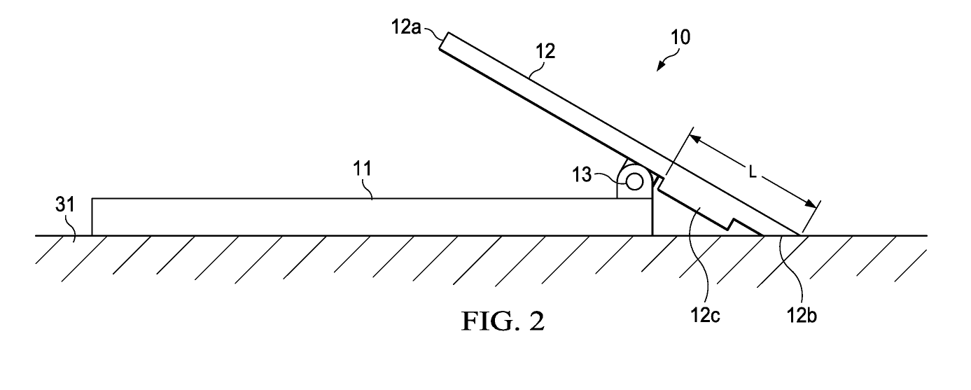

FIGS. 1 and 2 are a perspective and an end view, respectively, of the door holder 10. FIG. 1 illustrates door holder 10 viewed toward its non-hinged (open) side, and further shows an optional foot pedal 14 attached to one end of the door holder 10. The end view of FIG. 2 shows an end without a foot pedal 14. In both views, door holder 10 is shown in its “normally open” position, with top plate 12 tilting upwardly from the floor.

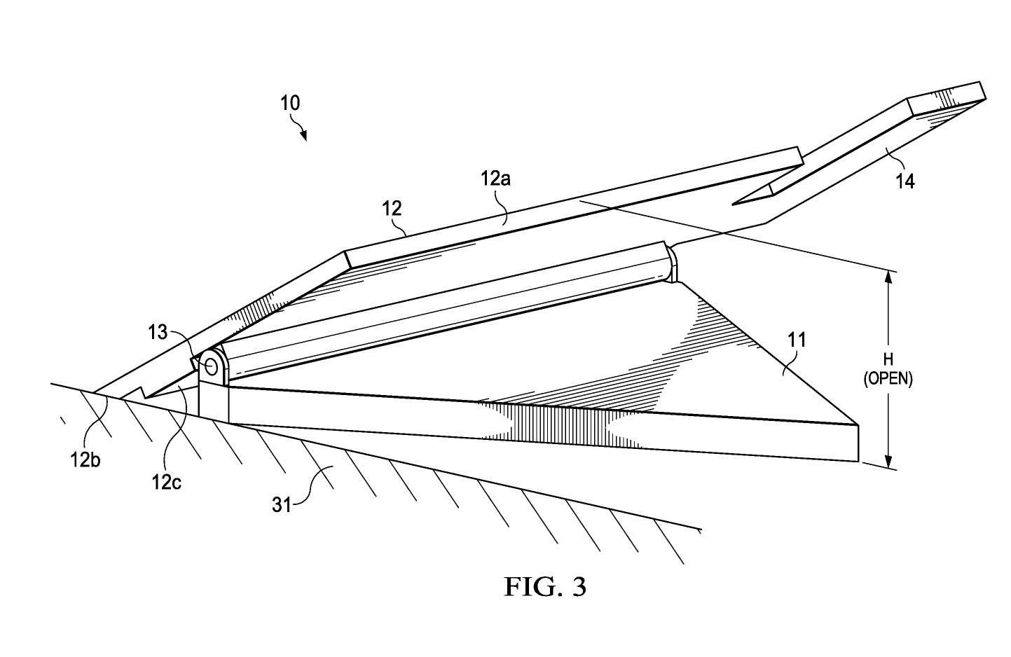

FIG. 3 is another perspective view of door holder 10, viewed from the opposite end as FIG. 1, and illustrating attachment to a floor 31. As explained below, when door holder 10 is installed on a floor, the end shown in FIG. 3 points generally toward the door hinge, and may thus be referred to as the “door” end of door holder 10. Thus, FIG. 1 illustrates door holder 10 from its “foot pedal end”, whereas FIG. 3 illustrates door holder 10 from its “door end”.

Door holder 10 comprises a base plate 11, top plate 12, hinge 13, and foot pedal 14. Hinge 13 attaches base plate 11 to top plate 12. As explained below, hinge 13 allows top plate 12 to pivot from the open position shown in FIGS. 1-3 to a closed position against base plate 11. A feature of the invention is that, rather than hinge 13 attaching top plate 12 to base plate 11 at abutting edges, hinge 13 attaches top plate 12 to base plate 11 at a location between an upper edge 12a and lower edge 12b of top plate 12.

As particularly shown in FIG. 2, top plate 12 has a weighted lower portion 12c that extends past hinge 13. This lower portion 12c is of sufficient weight such that it causes top plate 12 to tilt upwardly, that is, in the open position shown in FIGS. 1 and 2. In other words, top plate 12 and hinge 13 act as a “seesaw”, with the weight of lower portion 12c being gravitationally biased toward the floor. The bias weighting of top plate 12 in this manner eliminates the need for a spring or other means to bias top plate 12 to an open position.

The bias weighting of lower portion 12c may be assisted with a counterweight (as shown) or by other means, such as by making lower portion 12c of a substantially heavier material than, or thicker than, the rest of top plate 12. It is typically desired that the lower portion 12c of top plate 12 not extend a substantial distance past hinge 13. Typically, the distance from the hinge 13 to lower edge 12b is substantially less than the distance from the hinge 13 to upper edge 12a of top plate 12. Obviously, the heavier the bias weighting of bottom portion 12c, the less distance it is required to extend past hinge 13.

In the embodiment of FIG. 2, the geometry of the hinge height to the point of attachment to the top plate, as well as the length, L, of the lower portion 12c, are designed so that lower edge 12b touches the floor. As explained below, an advantage of edge 12b engaging the floor 31 is that friction between edge 12b and floor 31 may assist in holding door holder 10 in place. Lower edge 12b may be angled so that it may rest flat against the floor.

FIG. 3A is a side view illustrating top plate 12 in its upwardly tilted position. Door holder 10 is shown attached to a floor 31, and with the upper edge 12a of the top plate 12 holding a door 32 open. As illustrated in FIG. 3A, it is not necessary for operation of the door holder 10 that bottom edge 12b engage the floor.

As explained below, as a door is opened and passes over door holder 10, the pressure of the door against top plate 12 presses down on top plate 12, closing it toward base plate 11. This allows the door to pass over top plate 12. After the door passes over top plate 12, because of the bias weighting of top plate 12, top plate 12 returns to its open position, thereby holding the door open.

Foot pedal 14 extends from top plate 12, with a rigid attachment to top plate 12. Thus, when the door is desired to be closed, pressing foot pedal 14 downward toward the floor 31 will result in closing top plate 12 against base plate 11. The door 32 may then be moved over door holder 10.

Base plate 11 is generally flat and planar, and suitable for permanent or removable attachment to a floor. Various attachment means may be used, such as screws or glue, or any other means that does not impede the closing action of top plate 12 against base plate 11.

The particular placement of door holder 10 on a floor 31, relative to a door 32 is discussed below. The attachment means for securing door holder 10 to the floor may be by any suitable means, and may depend on the characteristics of the door being held open. That is, a heavier door may require a more robust attachment. In general, the attachment may be by any means that allows door holder 10 be securely fixed to the floor so as to hold a door open when door holder 10 is in operation.

Attachment means may also depend on the type of floor. For some floors and doors, attachment such as by screws into the floor may be required. For other floor and/or door configurations, attachment such as by a “hook and loop” strips on the floor and on the bottom of base plate 11 may be suitable. Other possible attachment means may include, without limitation, glue or other adhesive. The attachment may be permanent or removable.

In some cases, simple friction between the bottom of the base plate 11 and the floor 31 may be sufficient. As explained below, the ability of door holder 10 to hold door 32 open may be assisted by the bottom edge 12b of top plate 12 pressing against the floor.

In FIGS. 1-3A, the normally open position of door holder 10 results in an angle between base plate 11 and top plate 12 of about sixty degrees. In general, top plate 12 and the placement of hinge 13 are designed so that the open angle between base plate 11 and top plate 12 is a set angle, which typically ranges between thirty and sixty degrees. When top plate 12 is pressed against base plate 11, the angle between them is minimal (close to zero degrees).

As explained above, the attachment of top plate 12 to hinge 13 is such that a lower portion 12c of top plate 12 extends past hinge 13. This allows top plate 12 to pivot toward the floor 31, and to also be bias weighted on its lower portion 12c to its open position. Generally, this requires the attachment of hinge 13 to top plate 12 to be somewhat raised from the floor 31. A constraint on the height of hinge 13 away from the floor 31 is that the top plate 12 must be operable to close toward base plate 11 and allow door 32 to pass over the door holder 10.

Referring to FIGS. 1-3A, base plate 11, top plate 12 and foot pedal 13 may be made from various rigid materials. Typical materials are metals and hard plastics.

Base plate 11 and top plate 12 may be generally planar and thin, except perhaps where the lower portion 12c is thicker or otherwise weighted. Although they need not be the same thickness, a typical thickness is in the range of ¼ to ½ inch.

In various embodiments, top plate 12 and foot pedal 14 could be manufactured as one piece or two. In FIGS. 1 and 3, foot pedal 14 is shown as having a bridged attachment to top plate 12. As explained below, foot pedal 14 extends beyond the width of the door when door holder 10 is installed for operation. Other embodiments could include a top plate 12 that simply has a longer and possibly thicker (wider) portion at one end to form foot pedal 14.

Hinge 13 may be attached to, or integrated with, base plate 11 and/or top plate 12. In one embodiment, hinge 13 could be configured similarly to a butt hinge, that is, a series of alternating cylinders through which is positioned a round bar. Other hinges, such as barrel, pivot, or piano type hinges, may also be suitable. “Hinge” is meant here in the most general sense, to mean any attachment mechanism that allows the angle between base plate 11 and top plate 12 to vary between approximately zero and sixty degrees.

The perimeter geometries of base plate 11 and top plate 12 may vary. Typically, both have a long dimension of the same length, and a long side of top plate 12 is attached by hinge 13 to a long side of base plate 11. Typically, top plate 12 will have a second long straight side, against which the flat surface of door 32 engages when being held open. Various geometries for base plate 11, because one function is to provide secure attachment of door holder 10 to a floor, may be rectangular, triangular, or semicircular.

A typical overall width of door holder 10 (from its door end to its foot pedal end) is in the range of 4-6 inches (not including foot pedal 14). A typical length of top plate 12 is between 2 and 4 inches. If the width of door holder 10 is considered to be along the direction of hinge 13, door pedal 14 will extend from top plate 12 along that direction.

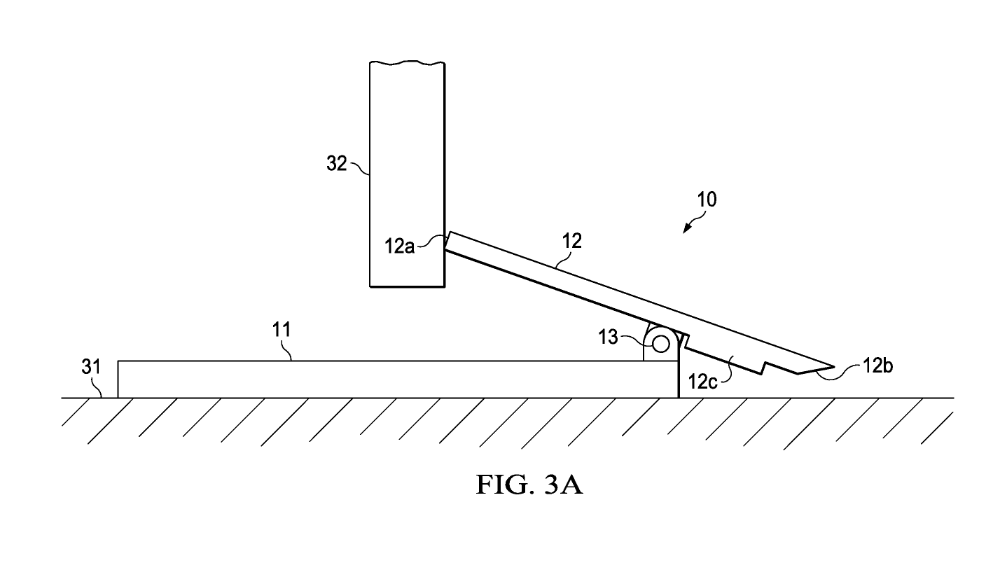

FIG. 4 illustrates how the closing of a door over door holder 10 causes the upper portion of top plate 12 to close toward base plate 11. As the door passes over door holder 10, the force of the door pressing against the top plate 12 causes the angle between top plate 12 and base plate 11 to decrease. This allows the door to pass over and past the door holder 10. In the example of FIG. 4, the thickness (height) of door holder 10 is a maximum of H-closed. As explained below, this height is related to the clearance between the door and the floor.

Because the door closes toward the hinged attachment side of door holder 10, the action of the door passing o over door holder 10 results in closing door holder 10. In other words, the door presses against top plate 12, and closes the angle between top plate 12 and base plate 12. Because of the gravitational bias of top plate 12, after the door passes over door holder 10, door holder 10 returns to its open position.

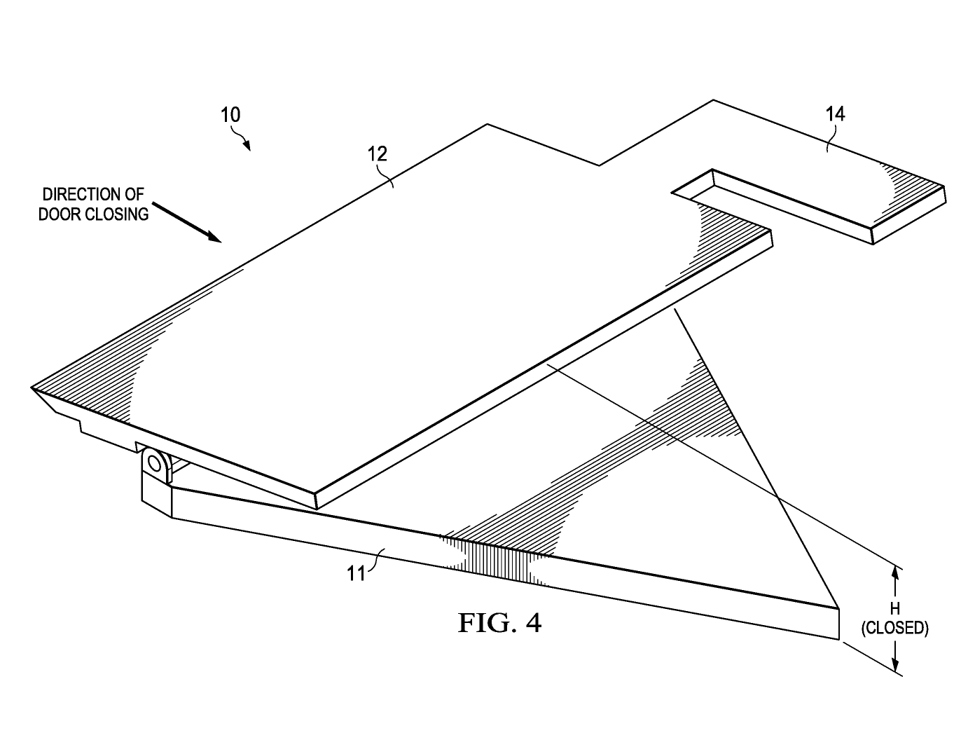

FIG. 5 illustrates door holder 10 attached to a floor, in its open position, holding a door 32 open against or close to a wall 60. The hinged side of door holder 10 faces outward from the wall 60. Door 32 has been opened toward and over door holder 10, thereby pushing top plate 11 downward toward base plate 11, as explained above.

After door 50 has passed over door holder 10, the gravitational bias of top plate 12 causes top plate 12 to tilt upward back into its open position. The top edge 12a of top plate 12 is a greater distance from the floor than the bottom edge 32a of door 50. As a result, door 32 is held open by top plate 12 and will not move past door holder 10.

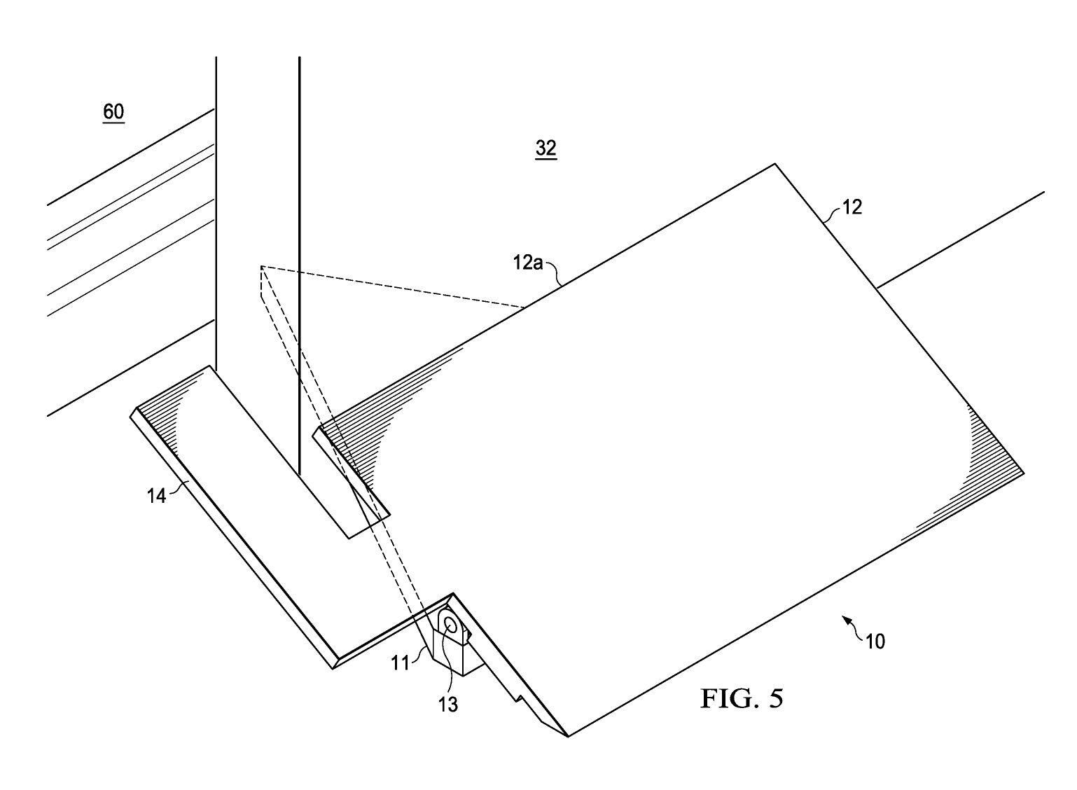

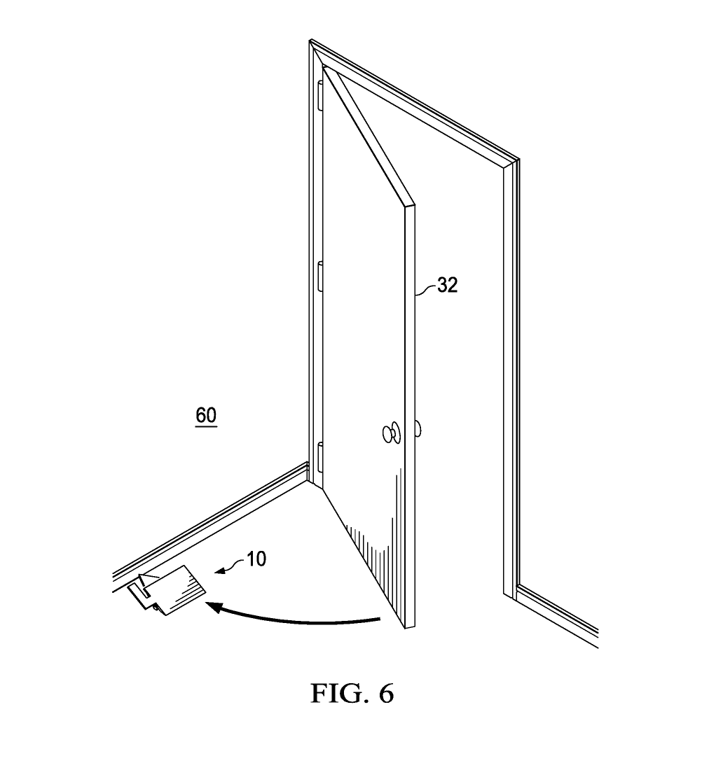

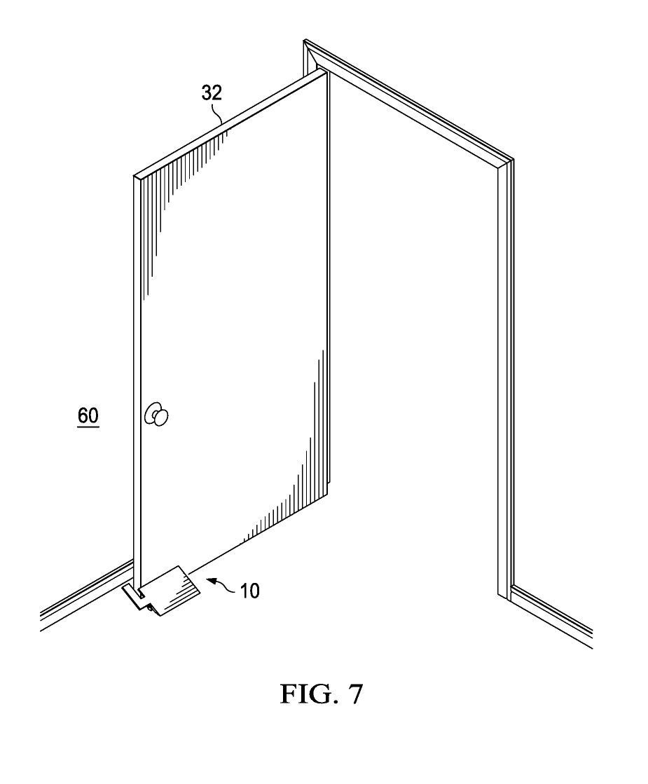

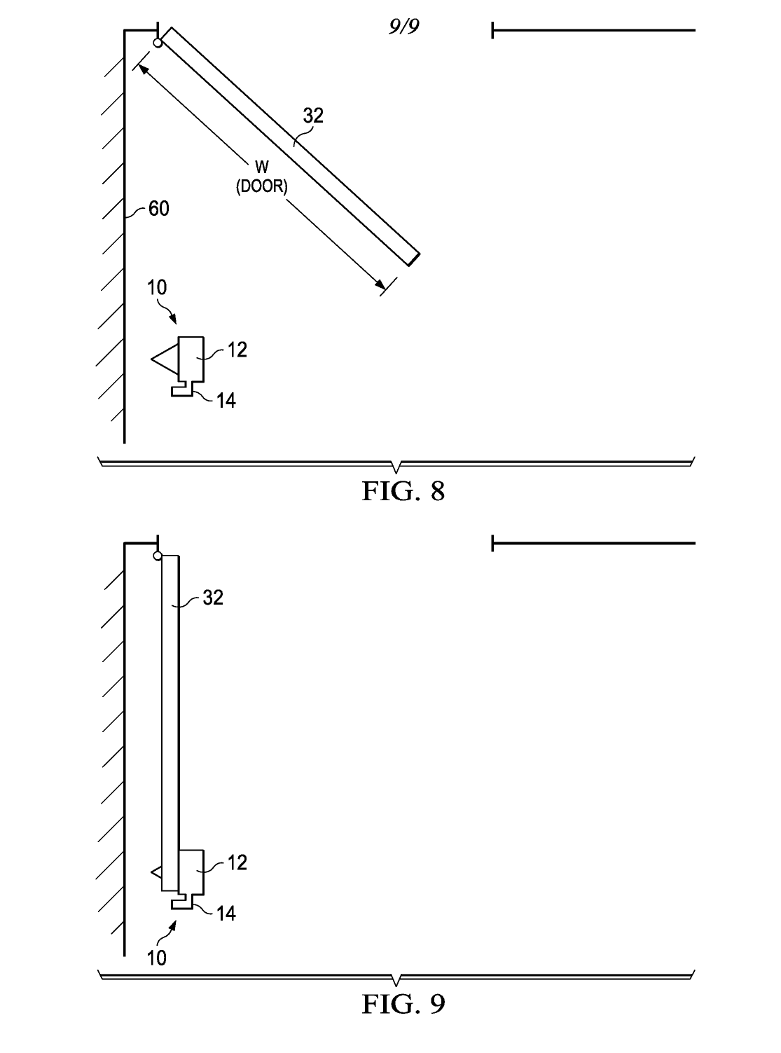

FIGS. 6-9 further illustrate the installation and operation of door holder 10. FIGS. 6 and 7 are perspective views, and FIGS. 8 and 9 are top views.

Door holder 10 is securely attached to a floor 31, as described above, with base plate 11 being attached flat against the floor. Door holder 10 is placed near a wall 60 against which the door 32 will open. The sides of door holder 10 are generally parallel to wall 60, but may be angled slightly outward to correspond to the angle of door 32 when it is opened to a desired distance from the wall. Other words, the more closely door 32 is to be held open against the wall 50, the more parallel will be the position of door holder 10 relative to wall 60. Also, depending how close door is desired to be held against wall 60, the distance between door holder 10 and wall 60 may vary.

In FIGS. 6 and 8, door 32 is partly closed, whereas in FIGS. 7 and 9, door 32 is open and being held in place by door holder 10. Because of the manner in which door 32 is hung, there is clearance between the bottom of door 32 and the floor 31. Door holder 10 has a maximum height (H-closed in FIG. 4) in its closed position, which is less than the clearance between the door's bottom edge 32a and the floor 31. Thus, when door holder 10 is in its closed position, door 32 may pass over the top of door holder 10.

However, during opening of the door, once door 32 passes over door holder 10, door holder 10 automatically resumes its open position, due to the gravitational bias of top plate 12. In this open position, the top edge 12a of top plate 12 has a height that is greater than the distance between the bottom edge 32a of door 32 and the surface of the floor. This height (H-open in FIG. 3) results in top plate 12 being sufficiently high so that at least its top edge 12a engages against the door to hold the door open.

As shown in FIG. 9, door holder is installed such that when door holder 10 is holding door 32 open, foot pedal 14 extends past the outer edge of door 32. This allows a person to simply use his or her foot to press down on foot pedal 14 when door 32 is desired to be closed. By pressing down on foot pedal 14, top plate 12 is pressed down against base plate 11. The now-reduced height of door holder 10 allows the door 32 to pass over door holder 10 and to be closed.

A feature of door holder 10 is that it is normally in its open position. As explained above, it is pressed closed by a door when the door is passing over it while the door is being opened, but returns to being open once the door passes over it. Also, door holder 10 becomes closed when the door 32 is desired to be closed and foot pedal 14 is pressed down, to allow the door to pass over it and be thereby closed.

It should be understood that in the example of this description, the door is to be closed against a wall and thus door holder is installed close to the wall. However, applications are imaginable in which a door may be desired to be held open but not necessarily against a wall.

It is also possible to use the above-described door holder for holding open a gate, provided the gate has a bottom piece to engage the upper edge of the top plate. For purposes of this description, a “gate” shall be considered equivalent to a “door”. The door-holder may be made suitably robust and durable for outdoor use.

For gate applications, the design of the bottom plate will depend on environment of the gate. If the gate is over pavement or similar surface, the bottom plate will have a flat surface for attachment. If the gate is over ground, the bottom plate may include some means for driving or otherwise securing the bottom plate to the ground.

What is claimed is:

1. A door holder for holding a door in an open position, the door being hung such that there is a gap between the bottom of the door and a floor, the door holder comprising:
a base plate having a flat bottom surface for attachment to the floor;
a top plate having a first straight upper edge for engagement with the door and a second straight lower edge;
a hinge for pivotally attaching the base plate to the top plate forward of the lower edge of the top plate, thereby defining an upper portion of the top plate between the hinge and the upper edge and a lower portion of the top plate between the hinge and the lower edge; and
wherein the lower portion of the top plate is shorter than the upper portion of the top plate and weighted such the top plate is biased by gravity to tilt upwardly.

2. The door holder of claim 1, further comprising a foot pedal rigidly attached to the top plate.

3. The door holder of claim 1, wherein the top plate is generally rectangular in shape.

4. The door holder of claim 1, wherein the lower edge of the top plate engages the floor when the top plate is tilted upwardly.

5. The door holder of claim 1, wherein the hinge is a barrel type hinge.

6. A gate holder for holding a gate in an open position, the gate being hung such that there is a gap between the bottom of the gate and a ground, the gate holder comprising:
a base plate having a bottom surface for attachment to the ground;
a top plate having a first straight upper edge for engagement with the gate and a second straight lower edge;
a hinge for pivotally attaching the base plate to the top plate forward of the lower edge of the top plate, thereby defining an upper portion of the top plate between the hinge and the upper edge and a lower portion of the top plate between the hinge and the lower edge; and
wherein the lower portion of the top plate is shorter than the upper portion of the top plate and weighted such the top plate is biased by gravity to tilt upwardly.

7. The gate holder of claim 6, further comprising a foot pedal rigidly attached to the top plate.

8. The gate holder of claim 6, wherein the top plate is generally rectangular in shape.

9. The gate holder of claim 6, wherein the lower edge of the top plate engages the ground when the top plate is tilted upwardly.

10. The gate holder of claim 6, wherein the hinge is a barrel type hinge.
